(19) United States
(12) Patent Application Publication
(10) Pub. No.: US 2002/0075290 A1
(43) Pub. Date: Jun. 20, 2002

(54) Incremental and interruptible layout of visual modeling elements

(75) Inventors: Vij Rajarajan, Redmond, WA (US); Casey L. Kiernan, Kirkland, WA (US); Stewart P. MacLeod, Woodinville, WA (US); Shawn E. Oberst, Maple Valley, WA (US)

Correspondence Address: Michalik & Wylie, PLLC, Suite 103, 14645 Bel-Red Road, Bellevue, WA, 98007, US

(73) Assignee: Microsoft Corporation

(21) Appl. No.: 09/742,781

(22) Filed: Dec. 20, 2000

(51) Int. Cl. G06F 3/00

(52) U.S. Cl. 345/700; 345/764

(57) ABSTRACT

Described is a method and system for interacting with a modeling layout algorithm that enables incremental and interruptible automatic layout operations. A defined set of interfaces (e.g., of a COM object) are described for layout engines, and a modeling engine calls into these interfaces to start and stop the layout process, preserve and restore state information, and perform other functions. The layout engine, which is preferably a pluggable component, raises events through an interface with which it complies to indicate its progress, and to indicate when the engine may be safely interrupted. The modeling engine can call back into the layout engine to stop the layout if the user has requested that the layout be interrupted, providing interfaces to the layout engine for preserving and restoring its state, thereby enabling incremental layout operations that do not lose progress.

### FIELD OF THE INVENTION

The present invention is generally directed to computer systems, and more particularly to visualization and modeling in computer systems.

### BACKGROUND OF THE INVENTION

Visualization and modeling software is extensively used in industry. Visualization generally refers to computer tools for viewing existing layouts, such as for viewing a representation of a network topology, an electrical wiring system or various other things that are designed. Visualization has general relevance in various applications, e.g., viewing a network topology is a scenario that is applicable to many different products. Modeling refers to computer tools used to design things, such as software, databases, integrated circuits, CAD/CAM applications and the like. Thus, in general, in visualization, a user looks at interconnected model elements placed on a viewing surface. In modeling, a user places the model elements on a work surface and connects them together in some manner. The semantics of connecting two or more model elements using other model elements is the fundamental operation in modeling and visualization.

At present, modeling tools include features to automatically and properly lay out these model elements (nodes and their connections) so that the layout looks better and/or is more efficiently organized than what the user laid out manually. However, as implemented in existing products, this feature does not scale to large numbers (e.g., thousands) of objects, as it takes a relatively long time to perform the automatic layout process. At the same time, these products do not allow users to interact with the layout process, at best allowing the user to cancel and restart the entire layout process. For example, a user that interrupts an automatic layout operation that is in progress has to restart the operation from the beginning.

### SUMMARY OF THE INVENTION

Briefly, the present invention provides a method and system that allows for incremental (partial) automatic layout operations, yet scales well to large numbers of nodes and/or connections. The method and system are substantially more convenient for users, and allow users interaction with the automatic layout process. For example, the present invention enables a running layout to be interrupted if the user does not want to wait for the entire layout to complete. However, unlike existing products, if a user interrupts the layout process, the user does not lose the work done to that point. In addition, the user may be given an indicator of the status (e.g., percent complete) of the ongoing layout progress, and can obtain an indication of the time remaining to complete the layout operation.

In one implementation, these improved features are accomplished via a defined set of interfaces (e.g., of a COM object) with which compatible layout engines comply. A Visualization and Modeling Engine (VME) calls into these interfaces to start and stop the layout process, enable the maintaining of state information, and perform other functions. The layout engine, which is preferably a pluggable component, raises events through an interface with which it complies to indicate the progress (e.g., as a percentage and/or a textual description of the progress it has made and the stage of layout it is in). The layout engine also calls an interface or raises an event to indicate when the engine may be safely interrupted, whereby VME can call back into the layout engine to stop the layout if the user has requested that the layout be interrupted. State is maintained such that the progress of the layout engine thus far is not lost, as the state can be restored as part of restarting of the layout engine.

Other advantages will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram generally representing a visualization and modeling framework (VMF) in which an automatic layout engine may be operated in an incremental and interruptible manner in accordance with an aspect of the present invention;

FIG. 3 is a block diagram generally representing exemplary components in the VMF in which an automatic layout engine may be operated in an incremental and interruptible manner in accordance with an aspect of the present invention;

FIG. 4 is a block diagram generally representing a physical architecture of the VMF in accordance with an aspect of the present invention;

FIG. 5 is a representation of a modeling surface window having model elements thereon capable of being automatically laid out in accordance with an aspect of the present invention; and

FIG. 6 is a flow diagram generally describing logical steps taken to provide incremental and interruptible layout of model elements in accordance with an aspect of the present invention.

### DETAILED DESCRIPTION OF THE PREFERRED EMBODIMENT

Exemplary Operating Environment

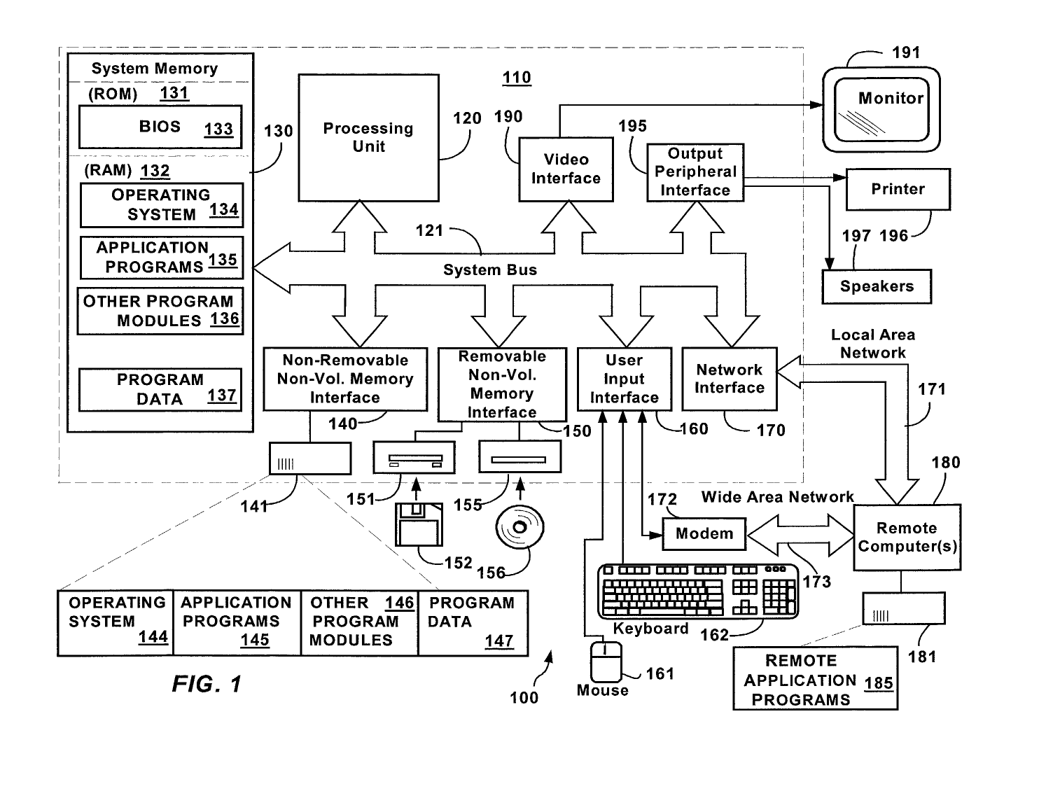

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/nonremovable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Visual Modeling Framework

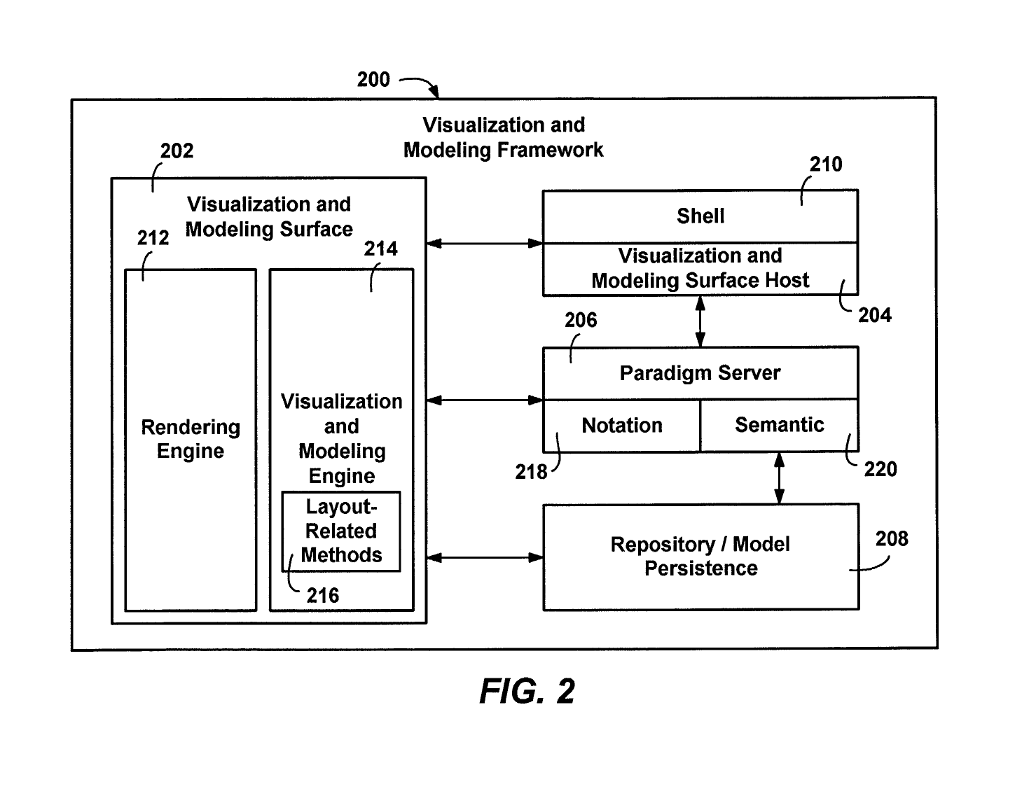

As generally represented in FIGS. 2-4, the Visualization and Modeling Framework (VMF) is a component-based framework 200 for visualization and modeling tools. VMF is a generalpurpose modeling tool having a paradigm-independent surface 202 capable of modeling numerous kinds of model elements. Nevertheless, unlike other diagramming tools, VMF is still capable of enforcing model semantics and constraints.

A minimum VMF architecture requires the surface 202, a host 204 and a paradigm server 206. Model persistence, such as in the form of a repository 208, is optional, but is very likely in many modeling scenarios, for example, to maintain properties and other information for model elements. The VMF components such as the surface 202, core graphic components and other components are designed to be reusable across modeling paradigms. For example, new model elements may be introduced by registering new paradigm servers (e.g., ActiveX® controls). Similarly, new project types may be introduced, (e.g., as ActiveX® servers). Some or all of the components that comprise the VMF 200 may be incorporated into an operating system, such as the operating system 135 (FIG. 1) of the computer 110.

The VMS host 204 is a tool that uses the services of the VMF 200 to solve a problem for the end user. In one straightforward situation, this tool may be a stand-alone executable program, wizard or add-in, with a specific problem domain for which it will provide solutions. For example, a simple host can be just a tool that hosts the surface 202 and a known paradigm server 206, e.g., a type-modeling tool may be created that utilizes a Unified Modeling Language (UML) paradigm server to model Visual Basic (VB) classes, and then generates the code for those VB classes.

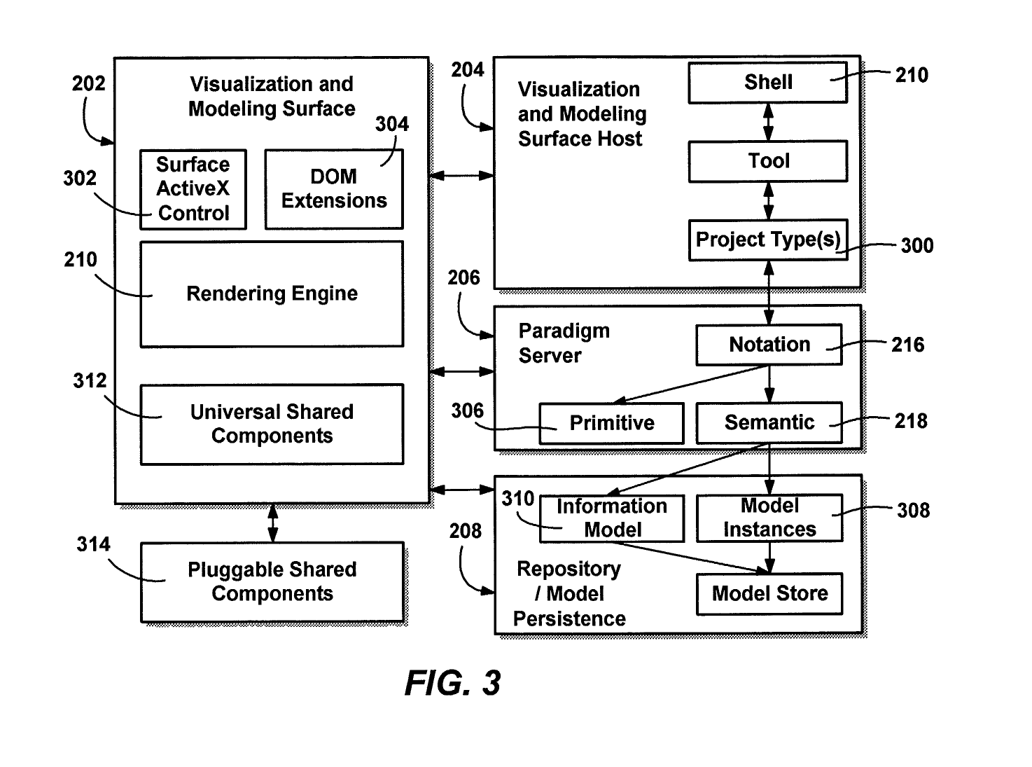

A more complex host may be a generic modeling tool that may be hosted through hosting layers in a variety of host shells, such as the shell 210 (FIG. 2). Such a modeling tool may model virtually anything, using one or more registered paradigms and one or more project types 300 (FIG. 3) dedicated to solving problems utilizing those paradigms in different problem domains. More complex hosts, such as a generic modeling tool, can be hosted in a number of shells (including VS, IE, MMC, and Access) through thin hosting layers to provide shell independence. As described below, these more-complex hosts may also implement the project types 300 (like VB project types) to provide scenario-based tool support for individual sets of paradigms without compromising paradigm independence.

In the VMF architecture represented in FIGS. 2 and 3, the visualization and modeling surface 202 comprises an HTML rendering engine 212 (e.g., browser and/or editor) such as found in Microsoft Corporation's Internet Explorer product. The surface 202 thus provides a complete HTML interpreter along with HTML editing capabilities. For example, the surface supports dynamic models built from Visual Basic and C++ ActiveX® controls and behaviors, as well as static models rendered in XML/VML.

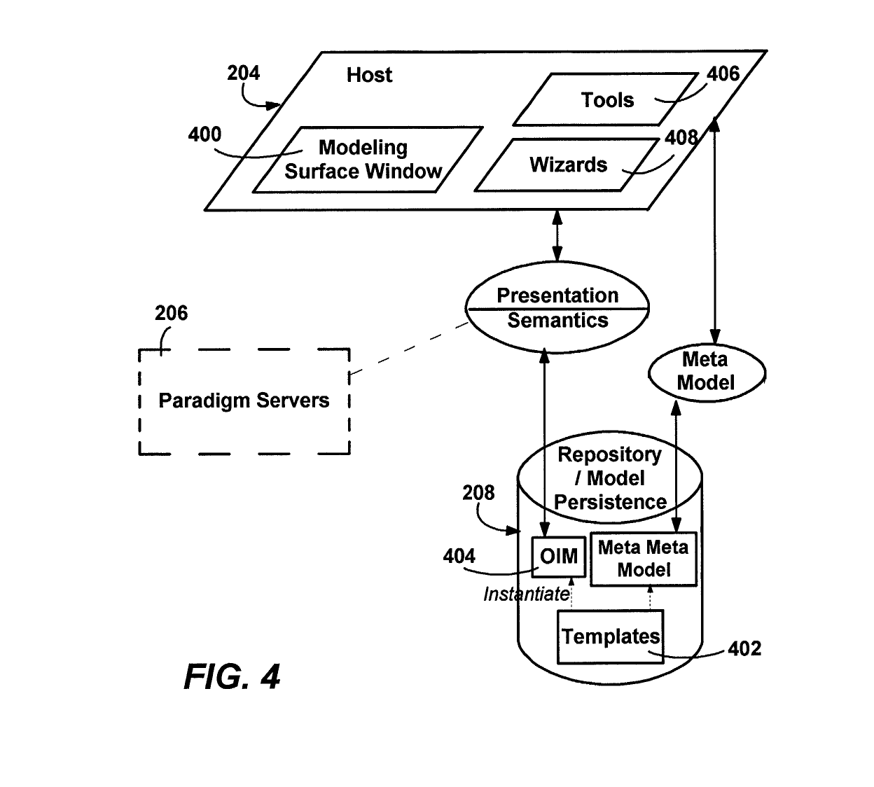

The surface 202 (which in one preferred implementation is an ActiveX® control) provides the actual drawing canvas on which model elements are arranged to form diagrams, represented in FIG. 4 as the modeling surface window 400. As described below, the surface 202 also acts as the central communication point for model elements to communicate with each other, including facilitating interconnection negotiations as further described in United States Patent Application entitled “Negotiated Interconnection of Visual Modeling Elements,” assigned to the Assignee of the present invention and herein incorporated by reference.

Most of the properties, methods and events of the surface 202 are directed to adding, editing and deleting model elements, and to managing the interactions between them. A preferred modeling surface, to be provided to third parties such as independent software vendors, is further described in United States Patent Application entitled “Dynamic, Live Surface and Model Elements for Visualization and Modeling,” assigned to the Assignee of the present invention and herein incorporated by reference. Note that while this surface 202 is rich, consistent and straightforward to use, the surface 202 provides a set of defined interfaces, and is thus capable of being replaced by an arbitrary component that supports the same set of interfaces.

The surface 202 also includes a Visualization and Modeling Engine (VME) 214 that provides additional support for rendering and editing models beyond that available via the rendering engine 212. In other words, via extensions, the VME 214 provides capabilities that the rendering engine 212 does not natively provide. For example, a more sophisticated way to determine whether one model element is above or in close proximity to another model element on the modeling surface, known as four-point hit testing, is not natively handled by the rendering engine 212, but is instead provided by the VME 214. Moreover, in accordance with one aspect of the present invention and as described below, the VME 214 includes layout-related methods 216 or the like (e.g., API functions) to handle interface with a layout engine component.

In one particular implementation using ActiveX® controls as represented in FIG. 3, a VMS host such as the host 204 may site the surface ActiveX® control 302, which provides standard ActiveX® interfaces to access the rendering engine 212. Any ActiveX® capability that the rendering engine 212 does not currently provide natively, such as the above-described four-point hit testing, are also provided by this surface ActiveX® control 302. Alternatively, thin clients may access most of the same capabilities of the VMS ActiveX® control with Dynamic HTML, utilizing Document Object Model (DOM) extensions 304.

As also represented in FIGS. 2-4, paradigm servers 206 provide notations and semantics to hosts, such as the VMS host 204, independent from the functional use of those notations and semantics. In one implementation, a paradigm server 206 may comprise an ActiveX® control server dedicated to providing and controlling the model elements of a single modeling paradigm. A paradigm server (e.g., 206) will often be broken apart into to separate notation and semantic servers.

In general, a notation server 218 provides the shapes of the paradigm, as well as the basic behaviors and rules for editing and connecting those shapes. Notation servers (e.g., 218) may be implemented as VB or C++ custom control servers, or, for thin clients, they may comprise “behaviors” of the rendering engine 212.

Semantic servers (e.g., 220) provide direct access to the notation independent model (meta-data represented by the model). This is particularly useful for non-graphical hosts, like wizards and generators. Semantic servers may be COM class servers or behaviors for thin clients. By way of example, one graphic primitive server (e.g., 306 of FIG. 3) provides base shapes such as lines, polygons and ellipses from which more complex shapes may be constructed, i.e., it provides basic shapes to utilize as building blocks for the more complex notation objects of a paradigm server. Typical examples of controls provided by this server include base nodes ranging from simple non-sizable icons to more complex polygons or ellipses and base arcs ranging from simple node centered non-routable single segment arcs to routable multi-segment arcs with semantic adornments. These building blocks may encapsulate both shared graphical behavior such as drawing, zooming, resizing, moving, hovering, and selecting, as well as shared modeling behavior inherent in the communication protocols with the surface, the host, semantic objects, and other notation objects. Thus, many complex behaviors such as zooming, resizing, moving and surface communication protocols are built directly into these primitive shapes, which, as can be readily appreciated, significantly simplifies the building of a notation server. Notation servers and semantic servers are further described in United States Patent Application entitled “Pluggable Notations and Semantics for Visual Modeling Elements,” assigned to the Assignee of the present invention and herein incorporated by reference.

A primitive server 306 shown in FIG. 3 (such as the graphic primitive server) may also provide any shared tools that multiple notations will likely wish to implement. For example, most model elements have some text which can often be formatted, and it would be inefficient for every paradigm server to contain its own text-formatting dialog and toolbar or in-place editing textbox. The graphic primitive server thus may contain these shared tools.

As further represented in FIG. 2, model persistence 208 may be provided as a generic pluggable component for a given tool. This component may be provided by the surface 202 or through a component known to the paradigm server 206. Persistence may be meta-model driven through information models or the paradigm server may already know the schema. More reusable paradigm servers will persist through a published persistence interface on a persistence component provided by the surface 202.

Model persistence is optional. If persisted, VMF models are preferably persisted in the Open Information Model (OIM) in the persistence/repository 208, and therefore can automatically be used by existing and future tools. OIM is based on the Unified Modeling Language (UML), which is a graphical language for visualizing and modeling. A suitable persistence stream for VMF is XML/VML, however additional persistence formats, such as repository objects or database record sets, may be provided to the host. Moreover, in VMF, models are persisted through published COM interfaces for OIM and UML, whereby the actual persistence component may be easily changed from repository 208, to database tables, to XML, or the like, without effecting the paradigm servers. This component architecture maximizes flexibility and extensibility and increases the preservation of investment in the individual components as the applications of those components change.

The model persistence/repository 208 is designed to be a point of interoperability for software vendors. Any information placed in the repository 208 can be read, updated and extended by any application with appropriate access to that repository 208. Since update access is exclusively through published (e.g., COM interfaces), adding application-specific extensions through new repository interfaces does not effect those applications already leveraging the existing interfaces.

As represented in FIGS. 3 and 4, the repository 208 may contain one or more models and/or templates 402, each of which may be composed of packages for organization. Templates 402 are static instances of models in the repository 208. They are usually designed to be examples or good starting points for modeling a vertical market domain, however they can also be design patterns (model structure templates) that can be utilized by wizards to apply a standard architectural design to a model. Many templates can be built dynamically as the user needs them through wizards.

A model instance 308 includes model elements, diagrams and the projections of those model elements onto those diagrams. If the model is persisted in a versioned repository 208 then a model instance includes the versions of model elements, diagrams and projections. Information models 310 specify the schema for persisting model instances. They are meta-models of model instances and contain meta-data about those instances. For example, the repository OIM 404 specifies the interfaces for persisting types, components and database entities. The schema of a particular database may comprise a model instance 308 of this information model 310.

As also represented in FIG. 3, the surface component 202 may provide universal shared components 312 that can be shared by hosts, such as to accomplish selection, hovering, zooming, and printing functions. Larger tools that may not be required by hosts and are thus optional may be provided as separate, shared pluggable components, including a pluggable automatic layout engine 314 and other pluggable shared components 316. This reduces the footprint requirements of smaller VMF applications that may not need these components, and the physical separation also makes it easy to provide several alternative implementations of these components. By way of example, model-independent persistence, such as XML/VML persistence, is a good candidate for a pluggable component because not every host will need every persistence mechanism, and indeed, some will not require a VMF provided persistence mechanism at all.

In keeping with the present invention and as described below, automatic graph layout is also a suitable candidate for a pluggable, shared component because layout algorithms are substantially different for different classes of modeling paradigms, and yet a single layout algorithm is often useful for many or all modeling paradigms within a class. Automatic layout is further described below, however it will be understood that the present invention will provide benefits with automatic layout mechanisms that are not otherwise considered pluggable, but instead, for example, are hard-coded into a tool.

FIG. 3 also shows a representation of project types, which plug into the host 204, e.g., through an application object. Project types may be UML-like collaborations described in the OIM of the repository 208. More particularly, each project type is a collaboration of modeling paradigms, tools 406 (FIG. 4), wizards 408, command bars and templates, registered in the repository 208 and designed to be used together to accomplish a task. Command bars comprise menu bars and toolbars, and act as the hooks that link the project type into the hosting environment (the surface 202 and shell 210). The tools 406 and wizards 408 of a project type 300 may be accessed through its command bars.

Project types can support a scenario, modeling paradigm, problem domain or an entire methodology. Virtually any scenario in the software development problem space may be addressed, e.g., abstraction layers, modeling paradigms, programming languages, product layers, product architectures, vertical market domains, development lifecycle and code architectures. Project types could be linked together into larger hierarchies to support many more complex scenarios.

Model Elements—Nodes and Arcs

In general, shapes rendered on the surface are collectively referred to as model elements, (or projections). In VMF, model elements are projected onto diagrams, (which in UML terminology is somewhat analogous to a projection being a single rendering of a model element on a view element). Each model element instance projected on a diagram corresponds to exactly one model element in a repository 208, however the same repository 208 model element may be projected onto multiple diagrams or even several times onto the same diagram.

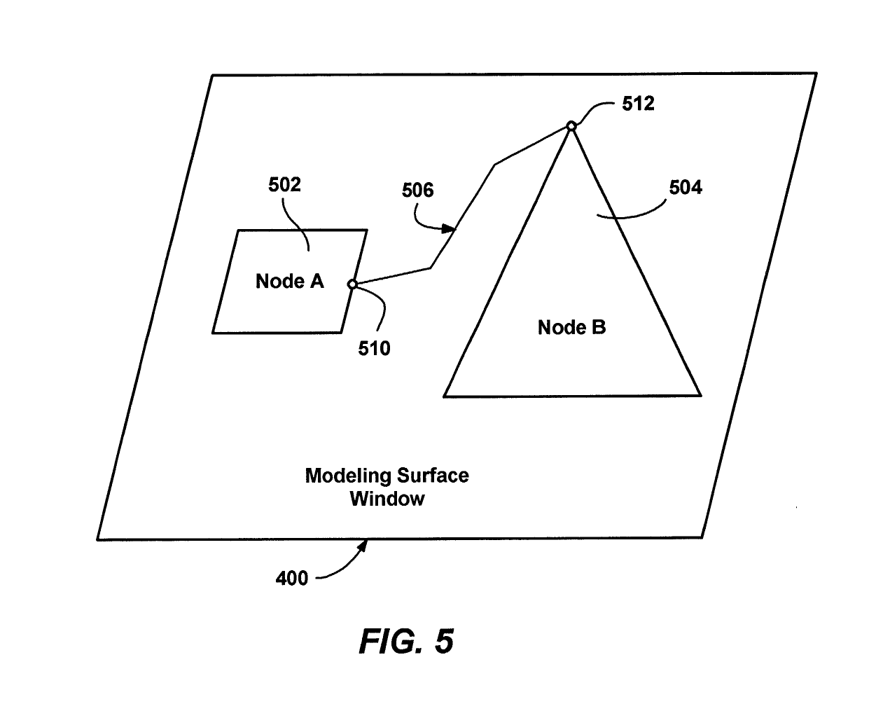

As generally represented in FIG. 5, each node 502, 504 is generally an icon, polygon, ellipse or other bounded shape, whereas an arc 506 is generally a line (possibly multi-segmented) that connects nodes (and sometimes other arcs) together. Arcs are used to connect two model elements together, semantically forming a relationship between the two. Model elements are typically peer ActiveX® controls on a window 400 of the surface 202. Properties of the model elements are persisted in the repository 208.

In one preferred embodiment, each model element in a model comprises an ActiveX® control. As such, each model element can autonomously control most of its presentation and much of its notational semantics. Usually, these controls will be light, windowless controls to improve scalability of models and therefore utilize the surface or graphic primitive server to provide basic windowing capability where required. Note that while the behavior of projects and diagrams is type-specific and is implemented in the project type, and the behavior of model elements and their projections is type-specific, and is implemented in one of the paradigm servers, the behavior of other elements is type-independent and is implemented in the surface server 202.

Each such model element thus also includes component interfaces, the primary purpose of which is to handle component communication between model elements, between a paradigm server and the model elements it serves, and between the surface and the model elements it contains.

As also represented in FIG. 5, the exact point where the arc touches either of these nodes is known as the attach point. In FIG. 5, the two attach points are labeled 510 and 512. The two attach points are conceptually owned by the arc but are managed by the surface 202. For example, the surface uses the attach points to determine whether other model elements may be affected when a model element is moved or resized, e.g., if a node is moved, then the arcs attached to that node will need to move with it. However, the surface 202 cannot move the affected model elements when an attach point moves, because it has insufficient information about how those projections should react to this move. In such an instance, the surface 202 is responsible for raising events so that each of affected model elements can respond properly to the change.

Layout Algorithms

All but the most-simple diagrams have their model elements initially laid out by the user in something less than an optimal manner for their intended purpose. For example, circuit board designs typically try to minimize the number of arc crossings, however this is a complex problem that is best done computationally rather than manually. In other designs, model elements may look better and/or operate more efficiently if spaced evenly rather than clustered in subgroups. Accordingly, automatic layout algorithms have been developed to computationally handle such tasks.

Automatic layout algorithms can be the most complex algorithms in a modeling tool. Because they are computationally too expensive to be employed generically, practical algorithms contain various heuristics to lower the computational expense at the price of some imperfection in the layout. The variations in the algorithms available are due to the types of heuristics employed, how many heuristics, and which imperfections were deemed most acceptable to the designer.

Because there are drawbacks to each, the algorithms that produce the best results base the acceptable imperfections on the semantics of the particular subject matter being modeled. In other words, they are specific to classes of modeling paradigms that contain the same subset of layout characteristics. However, employing paradigm-specific algorithms carries the additional development expense of implementing multiple separate, partially-distinct algorithms.

Most automatic layout algorithms that are practical for the above-described modeling domains have certain dominant layout characteristics that distinguish one from another. By way of example, scalability is one characteristic that needs to be considered, as many algorithms that produce visually appealing layouts do not scale well beyond about one hundred nodes because of computationally exponential cost. “Compact” layouts focus on having a minimal amount of white space (useful in circuit board design because of power consumption, race conditions, and manufacturing costs), while “Even” layouts attempt to use the available space with a roughly even load of semantic and/or visual information.

Other layout algorithms are directed to reduce crossing arcs, however this is computationally very expensive, and may not be ideal for designs where crossing is not as significant as other factors. The outer cycle algorithm is a heuristic variation on a region-based, least crossing arcs algorithm which does not suffer from the computational expense of such algorithms. The algorithm starts by laying out the largest cycle in the diagram, and defines two regions (inside the cycle and outside the cycle). The algorithm then moves to the next largest cycle, and the next, and so on, each time placing the cycle in whichever region still contains nodes to which elements of the cycle need to attach. However, to produce a compact diagram, multiple secondary algorithms are required. Also, the outer cycle algorithm cannot guarantee least crossing arcs for complex diagrams with many large crossing cycles, and it does not accommodate semantic attach points very well.

Connectivity algorithms center the diagram on the most-highly connected nodes (based on a cumulative shortest path to all other nodes). Nodes that are only connected to one other node are pushed toward the outer rim or into leftover white space. The primary focus of this algorithm is keeping connected nodes in very close proximity, which normally results in a very compact diagram with a reasonably visually even layout.

“Semantic affinity” refers to placing nodes that are strongly semantically coupled very close together, with nodes that are more loosely coupled placed further apart. Affinity algorithms are predicated on the idea that the purpose of a diagram is to communicate semantics, and that other characteristics of that diagram are relatively insignificant. These algorithms use the semantics of nodes to determine which nodes should be placed near each other and initially ignores line-routing implications. Affinity algorithms are thus extremely semantically even, but line routing cannot be accommodated well in secondary algorithms, and compact layouts cannot be produced since this is generally contrary to being semantically even.

Moreover, most layout algorithms make assumptions, some of which may not be proper for a given design. For example, some assume that an arc can attach to a node any place on that node, while others treat a node as a single point. However, if an arc must attach to a node at one or more specific points for semantic reasons, then this complicates other characteristics. Similarly, some algorithms assume that all nodes are exactly the same size, which are relatively simple to develop but conflict with most other characteristics.

Some algorithms allow new nodes to be added to existing diagram without greatly disturbing the existing layout, and are referred to as “incremental” algorithms. For example, the well-known directed force algorithm, which applies physical forces to the nodes, (like gravity toward the model center, springs with pulling connected nodes together, and repulsion between nodes), is an example of an incremental algorithm. These algorithms are drastically different than most others in that they a non-deterministic and difficult to reconcile with the other characteristics listed here. They are also significantly more computationally expensive than most other basic algorithms.

In sum, there are numerous automatic layout algorithms, each having their own benefits and drawbacks. The above-described architecture that incorporates the present invention facilitates pluggable algorithms. As a result, rather than limit a tool to a fixed algorithm, a particular algorithm (or multiple algorithms) that is best suited for a particular scenario may be employed. To this end, automatic layout algorithms are encapsulated in separate COM servers from the core the VME 214. This separation is important because there is a vast array of both paradigm-dependent and paradigm-independent layout algorithms that various tools may wish to employ. At the same, no single tool is likely to use more than a few of these algorithms. Because these algorithms can be both large and complex, a tool should not be forced to support and install unused algorithms. In this implementation, the automatic layout algorithms include the following methods:

Layout (Surface: MSVME, Gridsnap: Long)

This method lays out projections already sited on the surface provided. The logic behind how projections are laid out is completely algorithm-specific. The algorithm determines appropriate spacing for arcs and nodes using a gridsnap size. For example, if an arc is less than a gridsnap in width then multiple parallel arcs of that type will be placed exactly one gridsnap apart. However, if an arc is between two and three gridsnaps wide then multiple parallel arcs of that type will be placed exactly three gridsnaps apart.

LayoutProjections (Surface: MSVME, Gridsnap: Long, ProjectionIds: ProjectionId collection)

This method lays out projections identified by the ProjectionId collection on the surface. These projections need to be already sited on the surface provided. The algorithm takes the other projections on the surface but not in the ProjectionId collection into account when attempting the layout but cannot move them. In some cases, this will mean that the identified projections will be laid out in a completely separate part of the diagram.

Incremental and Interruptible Layout

In accordance with one aspect of the present invention, the visualization and modeling framework 200 (FIG. 2), and in particular the visualization and modeling engine (VME) 214 of the surface 202, interfaces with an automatic layout engine 314 in a manner that provides incremental and interruptible layout. To this end, the VME 214 and the layout engine 314 communicate through defined interfaces. In addition, the layout engine 314 can raise events that can be acted upon by interested parties, such as the VME 214.

As described herein, the layout engine 314 comprises a pluggable component in order to be consistent with the general component-based visualization and modeling framework, however it will be appreciated that the present invention is not limited to layout engines or the like that would be considered pluggable. Rather, the present invention will provide substantial benefits with any type of layout mechanism, as long as the layout algorithm conforms to the requirements (e.g., implements certain functions) set forth below. For example, instead of COM-based engines, virtually any mechanism may be implemented, such as by providing engines in the form of user-level processes that call system APIs.

In any event, as described above, the visualization and modeling framework 200 has an architecture where different layout algorithms can be plugged in as software components, or engines. To be pluggable, these layout engines (e.g., 314) preferably comply with specified COM interfaces. In keeping with the present invention, in addition to pluggability, the COM interface definition allows the layout algorithm to be structured as incremental and interruptible.

To this end, the interface has the following entry points:

1) Initialize: Initializes the layout engine 314. The VME 214 calls this entry point, passing in an interface to itself. The layout engine 314 calls into the passed VME interface to enumerate the various model element objects on the surface, obtain their positions, and obtain other related information.

2) StartLayout: The VME 214 calls this entry point of the layout engine 314 to start the layout process.

3) StopLayout: Stops the layout process. The VME 214 calls this when the user wants to stop the layout. In keeping with the incremental and interruptible nature of the present invention, the VME 214 passes an interface to the layout algorithm 314, which the layout engine uses to save the layout state. The VME 214 calls this only at points where the layout engine 314 indicates it is safe to stop the layout process. Note that for saving state, the persistence mechanism is the standard COM persistence mechanism, in which data is written and read as a stream, and each persisting component gets its own stream to save/restore its data.

4) RestartLayout: The VME 214 calls this to re-start a layout process that was previously stopped. The VME 214 passes in an interface via which the layout engine 314 can access its previously saved state information. Note that for restoring state, the persistence mechanism is the standard COM persistence mechanism, in which data is written and read as a stream, and each persisting component gets its own stream to save/restore its data.

5) EstimateTimeToLayout: Called at anytime by the VME 214, this call returns the time the layout engine 314 thinks it needs to complete layout. Instead of returning the remaining time estimate, the layout engine 314 can return with information indicating that it cannot provide the estimate now.

6) GetLayoutCapabilities: The VME 214 calls this to find out the capabilities of the layout engine 314. The information that can be obtained through this call includes the name of the layout algorithm, whether the engine can be interrupted, whether the engine can indicate progress through notifications, whether the engine can save state and be re-started, and so forth. This allows the VME 214 to work with layout engines that are not incremental and/or interruptible.

7) UnInitialize: Stops and unloads the layout engine 314.

The layout engine 314 also raises events through an interface to which it complies. The events it raises are:

1) Progress: Indicates the progress that the layout engine 314 has made as a percentage. The progress event also may provide a textual description of the progress it has made, and the current stage of layout. The event is described as follows:

Progress (ProgressPercentage: long, Cancel: boolean)

At important milestones and/or at regular time intervals, the algorithm typically raises this event. Preferably, this event should be raised approximately every one to three seconds during the layout process, but at the very least, it should be raised when the algorithm is complete. The progress percentage will be a number between zero and one hundred, indicating how much of the layout process has been completed. An application can respond to this event by setting a Cancel parameter to true. Setting this to true should terminate the layout process without changing the current position of any projection. Effectively, it should mostly leave all projections wherever they happen to be at the time of the cancellation, only making certain that they are visible.

2) SafeInterruptiblePoint: The layout engine 314 raises this event to indicate that it is in a safely interruptible point. The VME 214 can now call back into the layout through StopLayout (described above), e.g., if the user had indicated that layout should be interrupted. Note that when SafeInterruptiblePoint is called, any interruption that needs to happen happens within the context of the call. When the call returns to the layout engine, VME can no longer assume that the layout engine is safely interruptible.

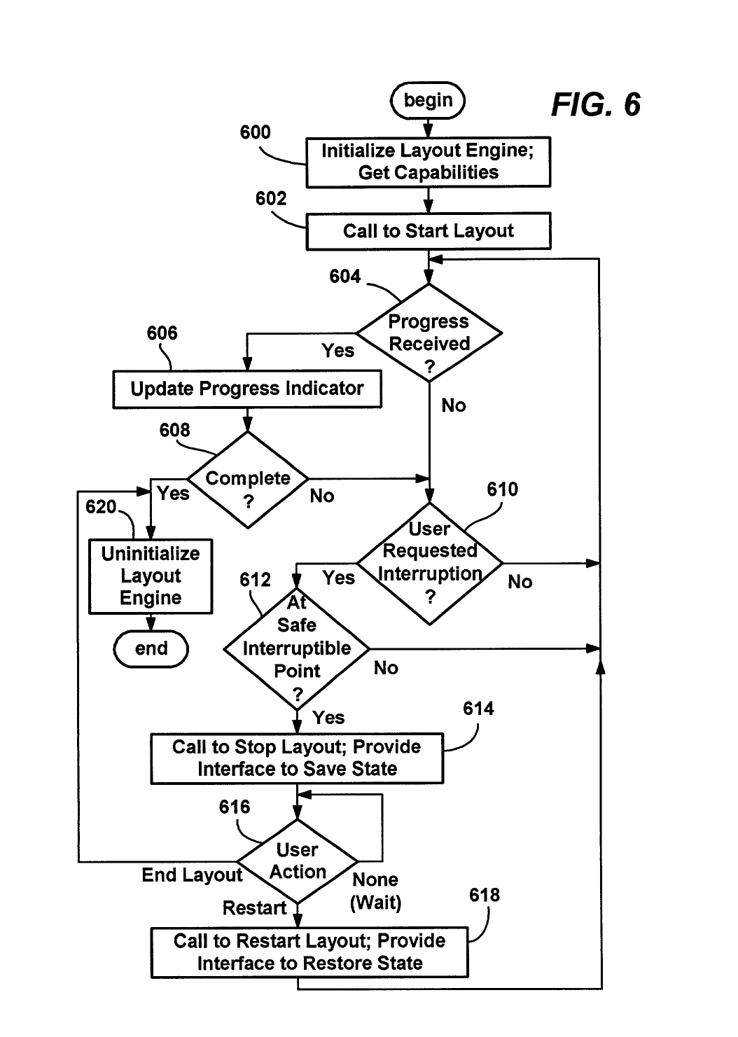

FIG. 6 provides a general description of the operation of the present invention from the perspective of the VME 214. While FIG. 6 is generally in the form of a flow diagram, it should be understood that many of the actions taken are actually event driven.

Beginning at step 600, the VME 214 initializes an appropriate layout engine using the initialize method, e.g., as directed by the tool based on some scenario. For example, a tool directed to circuit board design may instantiate a least crossing arcs type layout engine (e.g., the engine 314) when a user selects an “Autolayout” command or the like from a menu. The tool may calls into to VME 214 to perform the automatic layout operation, passing it the interface to the layout engine having the above-described entry points. Although separate, step 600 also represents the VME calling the above-described “GetLayoutCapabilities” method of the automatic layout engine to obtain its capabilities. For purposes of the present example, it is assumed that the initialized layout engine 314 is fully capable of incremental and interruptible operation in accordance with the present invention.

Step 602 represents the call by the VME 214 to start the automatic layout operation. At this time, the VME 214 essentially idles, waiting for some action by the user or event from the automatic layout engine. This is generally represented in FIG. 6 by the various loops back to step 604, (although instead of looping the VME is primarily event-driven, and thus the order of the actual events may not correspond to the evaluation order shown in FIG. 6).

Step 604 tests whether a progress event has been received from the layout engine. If not, the VME process of FIG. 6 continues to step 610, described below. Note that although not shown in FIG. 6, at any point the VME can attempt to find out how much time is remaining in the layout operation (along with any textual information the layout algorithm may provide) via the above-described EstimateTimeToLayout call. For example, such a call can be made on a periodic basis, or when a progress event has not been received for some overly-long period of time from the VME's perspective, and/or if the user expressly requests a time estimate.

If a progress event was received, the VME can update a progress indicator (e.g., progress bar) being displayed to the user. In this manner, the user can gauge the progress of the layout operation.

Step 608 represents an evaluation of whether the progress event indicated that the layout operation was complete. Note that this may be a separate event, or a regular progress event having a completion percentage value equal to one hundred. If complete, step 608 branches to step 620 where the layout engine is uninitialized, and the process of FIG. 6 ends. Note that the user may first be given a chance to review the results of the automatic layout operation, such as to undo it. Further, note that the layout engine need not be uninitialized at this time, but can be uninitialized at some later time.

In accordance with one aspect of the present invention, step 610 represents a test for whether the user has requested interruption of the layout operation, e.g., an event has been raised indicating this state, or a method of the VME is called with indicating this information. If interruption has not been requested, step 610 logically returns to step 604 to continue letting the layout algorithm operate, until the VME needs to act in some manner. If the user has requested interruption as determined at step 610, the VME tests at step 612 whether the layout engine has indicated (e.g., via an event) whether it is safely interruptible at this point, which only the layout algorithm can decide. As described above, the layout algorithm issues events to indicate whether it can be interrupted. If not at a safely interruptible point, step 612 branches back without taking action to interrupt the process. In this manner, the layout algorithm thus decides when it can be interrupted. Note that some cancellation mechanism can be used to cancel the layout engine if it is frozen, e.g., the VME can prompt the user to expressly cancel the layout (possibly losing any results thus far) if the layout engine has not appeared to act (e.g., issued any events) for some relatively long period of time.

If however at step 612 the layout engine had declared itself safely interruptible, step 614 is executed to stop the layout. In accordance with another aspect of the present invention, as described above, interrupting the layout engine includes passing the layout engine 314 an interface which it can use to call methods to preserve its current state. As a result, not only can the layout operation be safely interrupted during normal operation, but it can be essentially paused, maintaining whatever incremental progress has been made so far. The user can then decide how to proceed as represented by step 616 which waits for user action, e.g., via a dialog box.

For example, as represented by step 616, the user may choose to end the layout operation, with the elements as they are currently positioned, for further manual modeling operations or as a final design. Assuming that the original, pre-layout state was saved, the user can also undo what was done in the automatic layout operation.

The user can also restart the automatic layout operation, as represented by step 616 branching to step 618. If the user restarts, the VME 214 calls the layout engine 314 to restart the layout, providing it with an interface used to restore the state (that was previously preserved via step 614). After state restoration, the VME 214 process logically returns to step 604 to await further events and take any other actions (e.g., call for time remaining data) during the layout operation.

As can be seen from the foregoing detailed description, a user can interact with a layout operation, to see its progress, obtain its time remaining, and, because the layout engine can preserve and restore its state, safely interrupt it in a manner that does not cause a loss in incremental progress. While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computing device, a system comprising:
a modeling engine, the modeling engine connected to a user interface;
a layout engine, the layout engine connected to the modeling engine and configured to execute an automatic layout process that automatically lays out modeling elements; and
a set of at least one interface connecting the modeling engine to the layout engine, the set including at least one interface through which the modeling engine communicates with the layout engine to provide user interaction with the automatic layout process other than to cancel the automatic layout process.

2. The system of claim 1 wherein the modeling engine communicates with the layout engine by calls from the layout engine via the interface.

3. The system of claim 1 wherein the modeling engine communicates with the layout engine via events raised by the layout engine.

4. The system of claim 1 wherein the modeling engine communicates with the layout engine to provide a progress indicator to the user.

5. The system of claim 1 wherein the modeling engine communicates with the layout engine to obtain status information from the layout engine.

6. The system of claim 1 wherein the modeling engine communicates with the layout engine to interrupt the automatic layout process.

7. The system of claim 6 wherein the modeling engine communicates with the layout engine to preserve state of the automatic layout process.

8. The system of claim 7 wherein the modeling engine communicates with the layout engine to preserve the state of the automatic layout process by passing an interface thereto.

9. The system of claim 7 wherein the modeling engine communicates with the layout engine to restore the state of the automatic layout process, and to resume the automatic layout process.

10. The system of claim 9 wherein the modeling engine communicates with the layout engine to restore the state of the automatic layout process by passing an interface thereto.

11. The system of claim 1 wherein the layout engine comprises a pluggable software component.

12. The system of claim 1 wherein the modeling engine comprises a pluggable software component.

13. The system of claim 1 wherein the modeling engine communicates with the layout engine to obtain capability information from the layout engine.

14. A computer-implemented method, comprising:
starting a layout engine to lay out model elements;
receiving information from the layout engine indicating that it can be safely interrupted; and
interrupting the layout engine based on the information.

15. The method of claim 14 wherein receiving information comprises receiving an event.

16. The method of claim 14 further comprising, receiving a request to interrupt the layout engine, and waiting for the information from the layout engine indicating that it can be safely interrupted.

17. The method of claim 14 wherein the request comprises a user action.

18. A computer computer-readable medium having computer-executable instructions for performing the method of claim 14.

19. A computer-implemented method, comprising:
starting a layout engine to lay out model elements;
providing information to the layout engine by which the layout engine preserves state information;
interrupting the layout engine;
providing information to the layout engine by which the layout engine restores state from the state information; and
restarting the layout engine from the restored state.

20. The method of claim 19 wherein starting the layout engine includes communicating information to the layout engine through an interface thereof.

21. The method of claim 19 wherein providing information to the layout engine by which the layout engine preserves state information includes passing an interface to the layout engine.

22. The method of claim 19 wherein interrupting the layout engine includes communicating information to the layout engine through an interface thereof.

23. The method of claim 22 further comprising, receiving information from the layout engine indicating that it can be safely interrupted.

24. The method of claim 19 wherein providing information to the layout engine by which the layout engine restores state information includes passing an interface to the layout engine.

25. The method of claim 19 further comprising, receiving events from the layout engine.

26. The method of claim 25 wherein at least one of the events includes progress information.

27. The method of claim 19 further comprising, calling the layout engine to receive status information therefrom.

28. The method of claim 19 wherein the status information includes data corresponding to time remaining to complete laying out the model elements.

29. A computer computer-readable medium having computer-executable instructions for performing the method of claim 19.
